(19) United States
(12) Patent Application Publication
(10) Pub. No.: US 2005/0156045 A1
(43) Pub. Date: Jul. 21, 2005

(54) Combination lock and case or the like provided with a combination lock

(76) Inventor: Thorsten Steffen, Solingen (DE)

Correspondence Address: Martin A. Farber, Esq., 866 United Nations Plaza, Suite 473, New York, NY, 10017, US

(21) Appl. No.: 10/844,961

(22) Filed: May 13, 2004

(30) Foreign Application Priority Data
May 16, 2003 (DE) 103 22 605.2
Nov. 11, 2003 (DE) 103 52 577.7
Jan. 5, 2004 (DE) 10 2004 001 179.6

(51) Int. Cl. G06K 7/10

(52) U.S. Cl. 235/462.01

(57) ABSTRACT

Container which can be locked by a combination lock, in particular a case, bag or the like, wherein the opening combination of the combination lock can be seen with the aid of a reader or upon an x-raying of the container. The combination cannot be seen by a person viewing the container and/or the lock. The invention allows for an opening of the container by security personnel, as at an airport.

The invention relates to a container which can be locked by a combination lock, in particular a case, bag or the like.

The invention also relates to a combination lock for locking a container, in particular a case, bag or the like.

It is known from the prior art to provide cases, bags or the like with a combination lock. By entering the correct combination, for example by setting the number wheels in the appropriate position, it is possible for the combination lock, and thus also the container, to be opened.

Various forms of combination locks are known in the prior art, for example from DE 28 07 975, from DE 29 460 91, from DE 37 34 695 or from DE 10 319 068.

Cases which are locked by such combination locks require the correct opening combination to be set in the combination lock in order to be opened without the lock being destroyed. For this purpose, the number wheels are moved into the correct position.

In air travel, it is often necessary, for safety reasons, to open a piece of luggage, in particular a case or a bag, which has been checked in. Opening is carried out by an authorized individual, for example, the police or customs officials. It is necessary to open a case or a bag which arouses suspicion, in order to ensure that there are no unauthorized articles located within the case or the bag.

The object of the invention is for a combination lock of the generic type and a case, a bag or the like used with such a combination lock to be developed such that such opening is possible without the secure state which is achieved by the lock being put at significant risk.

The object is achieved by the invention specified in the claims. According to the invention, it is provided that the secret code, that is to say the opening combination of the combination lock, still cannot readily be seen from the outside, but can be seen with the aid of a reader or when the container is X-rayed. The second alternative in particular, that of rendering the opening combination visible when the container is X-rayed, can easily be realized in an airport. Here, the checked-in luggage is routinely X-rayed. According to the invention, it is provided that the symbol sequence of the opening combination, that is to say the three-digit to five-digit number, is disposed on an opening-combination carrier in a manner in which it is not visible from the outside, such that it is visible when the container is X-rayed. In the simplest scenario, this may take place in that the symbols are printed or marked with an ink which reflects or absorbs the radiation used for X-rays. The symbols of the opening combination are preferably disposed in the vicinity of the lock. It is also conceivable for a number of sets of the symbols to be disposed within the container, so that they can be seen in every direction during X-ray. The ink selected may be a lead-containing or metal-containing ink which is capable, in particular, of absorbing X-rays. The opening combination is then depicted as a cast shadow on the screen of the X-ray installation. If it is necessary for the piece of luggage to be opened, then it can be opened immediately following X-ray without the aid of any further auxiliary means, since the opening combination for the combination lock becomes apparent during the routine search. In a preferred configuration of the invention, it is provided that a sheet with stickers is added to each case or each bag or each lock. The sheet contains stickers with individual numbers. It is possible for these self-adhesive stickers, in accordance with the predetermined or user-selected secret locking code of the lock, to be stuck on at an appropriate location of the case or of the bag. A specific opening-combination carrier can be used for this purpose. It is also possible, however, for the stickers to be applied directly on the lock. It is, of course, also possible for the stickers to be affixed on the outside of the case shell. They are then preferably covered such that the covering can only be removed when the case is open, or with the covering being destroyed.

In a development of the invention, it is provided that the opening-combination carrier comprises mechanical elements which, when the combination lock is recoded, are displaced as well. Such mechanical elements may be wheels or slides which are provided with numbers or some other symbols which can be seen when the case or the bag is X-rayed. However, it is only the numbers which form the opening combination which are visible in this case. All other symbols or numbers may be covered in a suitable manner. The mechanical elements can be coupled in terms of movement to the number wheels of a combination lock. They may be capable of displacement within a housing. This housing has windows. The number belonging to the opening combination is then associated with the window in each case.

In a variant of the invention, it is provided that the opening combination can be read with the aid of a specific reader, for example by means of a barcode reader or of a transponder reader. The barcode may be provided at a suitable location on the outside of the case shell. Since the bar code contains the opening combination in encoded form, it cannot readily be seen by everyone. If the opening-combination carrier is a transponder, then the opening combination can be determined by a suitable transponder reader.

The opening-combination carrier may be located within the container, for example the case, separately from the lock. It is possible to provide means by which the opening-combination carrier can be fastened on the base of the case in order that the opening combination is always visible during X-ray through the broad sides of the case. The opening-combination carrier may have number discs. The number discs can carry individual numbers, which cast shadows during X-ray. The number discs may be capable of rotation. The individual numbers which form part of the opening-combination code may be located in a window which is marked by a frame which casts shadows during X-ray. The numbers which form the opening code can then be seen on the screen of the X-ray apparatus by the fact that they are located within a frame, the individual frames preferably being located one beside the other in a row. The numbered discs may be associated with the combination-code carrier in the manner of parking discs.

In a development of the invention, it is provided that the carrier, in addition to different symbols, also has different symbol parts for an opening-combination code. These symbol parts can be put together to form individual symbols, this being done by the user. The symbol parts may consist of metal or some other material which casts a shadow during X-ray. The opening-combination carrier may consist of plastics material or some other suitable material. The symbol parts may be diecast zinc bars which can be inserted in recesses of the symbol carrier. The recesses are preferably disposed in the form of an eight. The opening-combination carrier may comprise a plurality of symbol carriers. Each of these symbol carriers may have recesses for the symbol parts which are disposed in the form of a seven-segment arrangement, so that any number can be represented. A plurality of symbol carriers can be clipped together. The recesses may have openings into which a removal tool can be inserted in order to make it easier for the bars to be removed from the recesses. Moreover, the walls of the recesses may have set-back portions which make it easier for the bars to be removed. It is not just possible for the abovedescribed carrier to be disposed within a container, a travel bag or a case. It may also be located outside the case, albeit fixed to the same. Particularly suitable for this purpose are address tags, which are fastened for example on the handle of the case. This has the advantage that the reading of the opening combination is not impaired by the contents of the container. Moreover, the reader, for example an X-ray apparatus, may be of smaller configuration since it only has to X-ray the tag. In the case of this solution too, it may be provided that the carrier has individual, and individually arrangeable, symbol parts. The carrier may be disposed in an accommodating chamber of the tag. The chamber here may be configured such that it will be destroyed if opened. When the chamber is opened, the carrier is preferably adversely affected such that the code stored on it is no longer legible. This may be realized, for example, in that the opening of the chamber results in the symbol parts being rearranged. For example, it is possible for the individual symbol parts to drop out of the accommodating compartments of the opening-combination carrier.

An exemplary embodiment of an opening-combination carrier is explained hereinbelow with reference to accompanying drawings, in which:

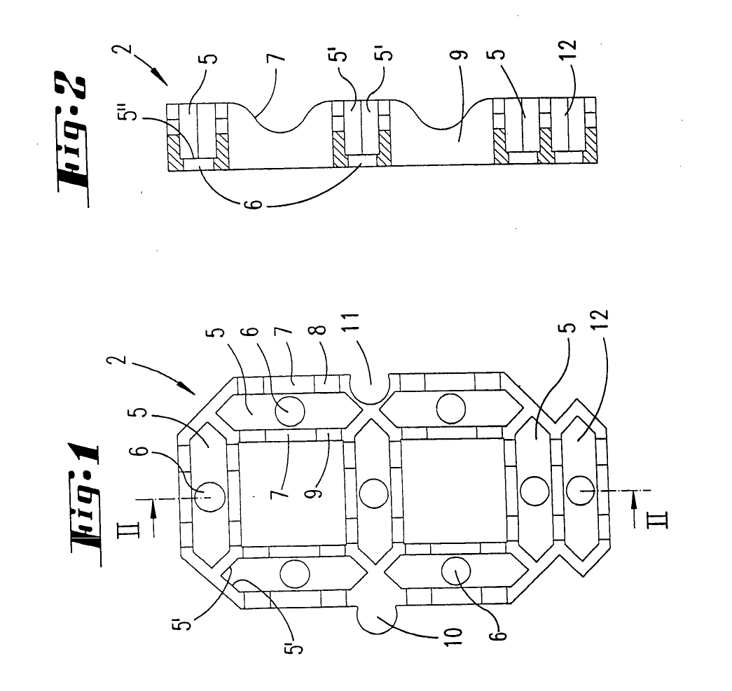

FIG. 1 shows the plan view of a symbol carrier of an opening-combination carrier,

FIG. 2 shows a section along line II-II in FIG. 1,

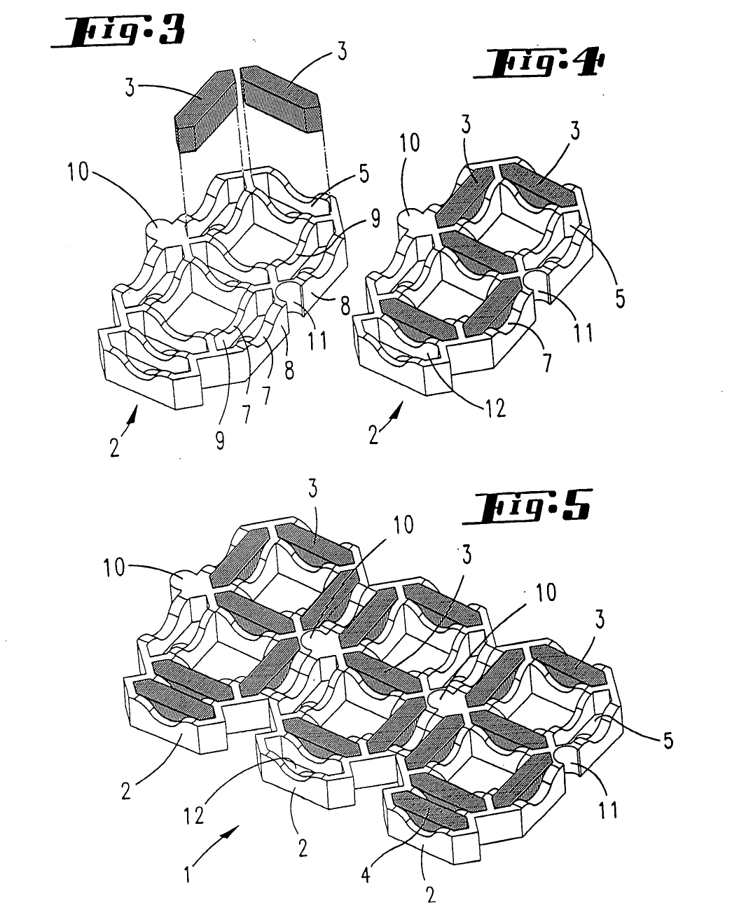

FIG. 3 shows the symbol carrier according to FIGS. 1 and 2, in perspective illustration, with two associated symbol parts,

FIG. 4 shows a perspective illustration according to FIG. 3 with symbol parts inserted in recesses, and

FIG. 5 shows a perspective illustration of an opening-combination carrier which comprises a plurality of symbol carriers and has recesses filled to give the number combination 956.

The symbol carrier 2 illustrated in FIGS. 1 and 2 consists of plastics material or some other material which does not cast a shadow during X-ray. The symbol carrier 2 has recesses 5 disposed in the form of a seven-segment arrangement. The recesses 5, seven in total, are disposed in the form of an eight. Each of the recesses 5 has an outer wall 8 and an inner wall 9. The inner wall 9 is oriented in the direction of a square clearance. The two walls, outer wall 8 and inner wall 9, have a base 5″ and end flanks 5′ which taper to a point on their narrow sides. The base 5″ of each recess 5 has a circular base opening 6. In addition, the symbol carrier 2, alongside a lower recess 5, has a recess 12 which runs parallel to the latter recess and is intended for accommodating an orientation symbol 4.

The recesses 5, seven in total, and the additional recess 12 of the symbol carrier 2 may each be fitted—as is indicated in FIG. 3—with a bar 3. The bar 3 consists of metal, for example diecast zinc, or some other material which casts a shadow during X-ray. The outer contour of each bar 3 corresponds to the inner contour of the recess 5. If the bars 3 are inserted into the recesses 5, they are retained there in a frictionally locking manner. The symbol parts 3 are seated with a clamping fit in the respective recess 5. The set-back portions 7 of the outer wall 8 and inner wall 9 allow the bars 3 to be drawn out of the recess 5 by the thumb and forefinger. In addition, the base 5″ has the abovementioned base opening 6, through which it is possible to insert a removal tool in order to remove a bar 3 from a recess 5.

The symbol carriers 2 form a latching tenon 10 in the centre of one longitudinal wall and an associated latching niche 11 in the centre of the opposite longitudinal wall. This configuration allows two or more symbol carriers 2 to be clipped together, in which case a latching tenon 10 of one symbol carrier is clipped into a latching niche 11 of another symbol carrier 2 in each case. FIG. 5 shows an opening-combination-carrier arrangement comprising three symbol carriers. In this figure, the recesses 5 are fitted with bars 3 to form the number 956. In order to indicate where the top and bottom are to the reader of the opening combination, each symbol carrier 2 has the abovementioned additional recess 12 for accommodating an orientation symbol 4. The orientation symbol 4, which is illustrated in FIG. 5, is configured in the same way as a bar 3, but serves merely to indicate where the top and bottom are to the reader of the opening combination. Supplementary orientation symbols may be provided in order to mark right and left.

The latching niche 11 which is free in the opening-combination carrier illustrated in FIG. 5 and/or the free latching stub 10 can be utilized in order to fasten the opening-combination carrier 1 on the inside of the case. For this purpose, corresponding mating latching means may be formed on the inside of the case. These mating latching means may also be associated with a bracket which can be adhesively bonded into the lid of the case.

In an exemplary embodiment which is not illustrated, the opening-combination carrier 1 which is illustrated in FIGS. 1 to 5, and comprises a plurality of symbol carriers 2, is associated with a tag, which may be, for example, an address tag which can be fastened on the handle of a case. The symbol carriers 2 here are associated with a chamber of this tag. The chamber may comprise two plastics-material shells which are fixed to one another and are non-transparent, so that the opening combination cannot be seen from the outside. For example, it is possible for two half-shells to be clipped to one another. In this solution, the symbol parts, for example the bars 3, may be positioned loosely in the recesses 5 associated with them. Measures are taken to ensure that opening of the chamber, for example separation of the half-shells which form the chamber, results in the symbol parts 3 dropping out of the recesses 5 which are associated with them. Consequently, if an attempt is made to open the case, the code cannot be seen with the naked eye.

Locating the opening-combination carrier 1 outside the case has the advantage that the code reader may be smaller. It does not have to X-ray the entire case. Nevertheless, it is ensured that the opening combination can also be rendered visible by a reader by means of which the entire case can be X-rayed. During X-ray, the tag can be moved into an appropriate position, so that the code can be seen right away. A further advantage of this variant of the invention is that the code can be read without obstruction. Metallic articles located in the case do not form an obstruction.

All features disclosed are (in themselves) pertinent to the invention. The disclosure content of the associated/attached priority documents (copy of the prior application) is hereby also included in full in the disclosure of the application, also for the purpose of incorporating features of these documents in claims of the present application.

1. Container which can be locked by a combination lock, in particular a case, bag or the like, wherein the opening combination of the combination lock can be seen with the aid of a reader or upon an x-raying of the container.

2. Container according to claim 1, wherein a symbol sequence of the opening combination is disposed on an opening-combination carrier which is not visible from the outside, such that it is visible when the container is X-rayed.

3. Container according to claim 1, wherein the symbols of a symbol sequence of the opening combination are printed or marked with an ink which reflects or absorbs the radiation used during X-ray.

4. Container according to claim 2, wherein the symbol-carrying opening-combination carrier, concealed on the inside or outside of the container, is disposed in the vicinity of the lock, in particular on a bracket which carries the lock.

5. Container according to claim 1, wherein the symbols of the opening combination are formed as stickers.

6. Container according to claim 2, wherein the opening-combination carrier is a transponder or a barcode strip.

7. Combination lock for locking a container, in particular a case, a bag or the like, wherein an opening combination of the combination lock can only be seen with the aid of a reader or upon an x-raying of the container.

8. Combination lock according to claim 7, comprising a sheet with stickers of individual symbols which can represent all possible opening combinations and can be seen during X-ray.

9. Combination lock according to claim 7, wherein, when the lock is recoded, the opening combination of the lock, which is carried by an opening-combination carrier and can be seen with the aid of a reader or when the carrier is X-rayed, changes as well.

10. Combination lock according to claim 7, wherein the opening-combination carrier comprises mechanical elements which, when the combination lock is recoded, are displaced as well, the mechanical elements carrying symbols which can be moved from a distinguishable position into a non-distinguishable position.

11. Carrier for an opening-combination code of a combination lock, operative with variable symbols of an opening combination which can be seen upon an x-raying of the carrier.

12. Carrier according to claim 11, wherein the symbols comprise a plurality of symbol parts (3) which can be associated with a symbol carrier in different variations.

13. Carrier according to claim 12, wherein the symbols or symbol parts (3) are associated with one or more symbol carriers (2).

14. Carrier according to claim 12, wherein the symbol parts (3) or symbols consist of metal or some other material which casts a shadow during X-ray.

15. Carrier according to claim 12, wherein the symbol parts (3) can be inserted in recesses (5) of the opening-combination code carrier.

16. Carrier according to claim 15, wherein the recesses are disposed in the form of one or more seven-segment arrangements, and the symbol parts (3) are of bar-like formation.

17. Carrier according to claim 12, wherein the symbol parts (3) are inserted with a clamping fit into the recesses (5).

18. Carrier according to claim 12, further comprising openings (6) which are associated with bases of the recesses (5), and enable an insertion of a tool for removing a symbol part.

19. Carrier according to claim 11, wherein a plurality of individual opening-code-combination carriers (2) can be combined with one another, in particular can be plugged together.

20. Carrier according to claim 11, wherein the carrier is a constituent part of a tag.

21. Carrier according to claim 11, wherein the tag has a carrier-accommodating chamber which cannot be opened without being destroyed.

22. Carrier according to claim 21, wherein the symbols comprise a plurality of symbol parts (3), and an opening of the chamber results in the carrier being destroyed at least to an extent where an arrangement of the symbol parts (3) is no longer legible or is changed.
